(19) United States
(12) Patent Application Publication
(10) Pub. No.: US 2020/0234337 A1
(43) Pub. Date: Jul. 23, 2020

(54) INFORMATION PROCESSING APPARATUS, INFORMATION PROCESSING SYSTEM, AND METHOD OF INFORMATION PROCESSING

(71) Applicant: TOYOTA JIDOSHA KABUSHIKI KAISHA, Toyota-shi (JP)

(72) Inventors: Shinichiro FUJII, Kawasaki-shi (JP); Hiroe Fukui, Toyohashi-shi (JP); Takashi Goto, Okazaki-shi (JP); Tatsuya Shigekiyo, Okazaki-shi (JP); Kuniaki Jinnai, Nagoya-shi (JP); Naoto Sasagawa, Nishio-shi (JP)

(73) Assignee: TOYOTA JIDOSHA KABUSHIKI KAISHA, Toyota-shi (JP)

(21) Appl. No.: 16/702,675

(22) Filed: Dec. 4, 2019

(30) Foreign Application Priority Data
Jan. 17, 2019 (JP) 2019-006334

(51) Int. Cl. G06Q 30/02; G06K 9/00; G06T 7/73

(52) U.S. Cl. CPC G06Q 30/0266; G06Q 30/0246; G06T 2207/30252; G06K 9/00778; G06T 7/74; G06K 9/00791

(57) ABSTRACT

An information processing system includes a vehicle and an information processing apparatus. The vehicle includes a display device disposed facing outside, and a first control unit configured to execute control so as to display advertisement information on the display device. The information processing apparatus includes a second control unit configured to execute: acquiring a congestion degree of persons present around the vehicle; and determining a display position of the advertisement information on the display device in accordance with the congestion degree. When the congestion degree is equal to or greater than a first threshold, the information processing system determines a display region of the advertisement information to be an upper region on a display screen of the display device.

### INCORPORATION BY REFERENCE

The disclosure of Japanese Patent Application No. 2019-006334 filed on Jan. 17, 2019 including the specification, drawings and abstract is incorporated herein by reference in its entirety.

### BACKGROUND

### 1. Technical Field

The present disclosure relates to an information processing apparatus, an information processing system, and a method of information processing.

### 2. Description of Related Art

It has been proposed to acquire surrounding environment, acquire advertisement information corresponding to the surrounding environment from a server, and display the acquired advertisement information on a display unit included in a vehicle (see, for example, Japanese Patent Application Publication No. 2016-065938).

### SUMMARY

An object of one aspect of this disclosure is to provide an information processing apparatus, an information processing system, and a method of information processing, capable of presenting easily viewable advertisement information that is displayed on a display device included in a vehicle, the display device being disposed facing outside.

One aspect of the present disclosure is an information processing apparatus, including a control unit. The control unit is configured to execute: acquiring a congestion degree of persons present around a vehicle including a display device disposed facing outside; and determining a display position of advertisement information on the display device in accordance with the congestion degree.

Another aspect of the present disclosure is an information processing system, including a vehicle and an information processing apparatus. The vehicle includes a display device disposed facing outside, and a first control unit configured to execute control so as to display advertisement information on the display device. The information processing apparatus includes a second control unit configured to execute: acquiring a congestion degree of persons present around the vehicle; and determining a display position of the advertisement information on the display device in accordance with the congestion degree.

Still another aspect of the present disclosure is a method of information processing, including acquiring a congestion degree of persons present around a vehicle including a display device disposed facing outside; and determining a display position of advertisement information on the display device in accordance with the congestion degree.

According to the one aspect of the present disclosure, it is possible to present easily viewable advertisement information that is displayed on the display device included in the vehicle, the display device being disposed facing outside.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 shows an example of the system configuration of a vehicle advertisement display control system according to a first embodiment;

FIG. 2 shows an example of transition of a display region of advertisement information on a display device of the vehicle;

FIG. 3 shows an example of the hardware configuration of the vehicle;

FIG. 4 illustrates the hardware configuration of a center server;

FIG. 5 shows an example of the functional configuration of the center server and the vehicle in a vehicle advertisement display control system;

FIG. 6 shows an example of an advertisement information management table held in an advertisement information DB;

FIG. 7 is an example of a flowchart for an advertisement display position control process of the center server; and

FIG. 8 is an example of an appearance view of a vehicle including the mechanism for pulling up a display.

### DETAILED DESCRIPTION OF EMBODIMENTS

One aspect of the present disclosure is an information processing apparatus including a control unit configured to execute: acquiring a congestion degree of persons present around a vehicle that includes a display device disposed facing outside; and determining a display position of advertisement information on the display device in accordance with the congestion degree.

According to one aspect of the present disclosure, when the congestion degree changes, the display position of the advertisement information on the display device is also changed. For example, when the display position of the advertisement information is determined, in accordance with the change in congestion degree, to a position easily viewable from the surrounding persons, it is possible to present more easily viewable advertisement information.

In one aspect of the present disclosure, when the congestion degree is equal to or greater than a first threshold, the control unit may be configured to determine a display region of the advertisement information to be an upper region on a display screen of the display device. Accordingly, when the surroundings of the vehicle become congested, the advertisement information is displayed on an upper region on the screen of the display device. Therefore, the persons who are, for example, distanced from the display device or in the congestion can also visually recognize the advertisement information with ease.

In one aspect of the present disclosure, when determining the display region of the advertisement information to be the upper region on the display screen, the control unit may be configured to determine reduced display of the advertisement information such that the advertisement information is all fit in the upper region on the display screen. Therefore, the persons who are distanced from the display device can also visually recognize the entire advertisement information with ease.

In one aspect of the present disclosure, when determining the display region of the advertisement information to be the upper region on the display screen, the control unit may be configured to determine to display part of the advertisement information on the upper region on the display screen. Even in the situation where the surroundings of the vehicle are congested, and it is hard to visually recognize the entire advertisement information, part of the advertisement information can be presented in the upper region on the screen of the display device, which makes it possible to make an appeal to an advertising target.

In one aspect of the present disclosure, when the congestion degree is less than a second threshold that is equal to or less than the first threshold, the control unit may be configured to determine the display region of the advertisement information to be an entire region of the display screen. Accordingly, when the congestion around the vehicle is eliminated, the advertisement information is displayed on the entire screen of the display device of the vehicle. As a consequence, a larger display of the advertisement information can be presented to allow easier visual recognition.

In one aspect of the present disclosure, when the congestion degree is equal to or greater than the first threshold, the control unit may be configured to determine to pull up the display device to a prescribed height. With the configuration, the persons who are, for example, distanced from the display device or in the congestion can also visually recognize the advertisement information with ease, without the necessity of changing the display size of the advertisement information.

In one aspect of the present disclosure, the control unit may be configured to acquire the congestion degree from an image imaged with an imaging device included in the vehicle, the imaging device being disposed facing outside. With the configuration, a more accurate congestion degree around the vehicle can be acquired.

An aspect of the present disclosure can also be defined from the standpoint of an information processing system and a method of information processing. The information processing system includes a vehicle and an information processing apparatus. The vehicle includes a display device disposed facing outside, and a first control unit configured to execute control so as to display advertisement information on the display device. The information processing apparatus includes a second control unit configured to execute: acquiring a congestion degree of persons present around the vehicle, and determining a display position of the advertisement information on the display device in accordance with the congestion degree. The method of information processing includes: acquiring a congestion degree of persons present around a vehicle including a display device disposed facing outside; and determining a display position of advertisement information on the display device in accordance with the congestion degree. The technical idea disclosed regarding the method of information processing described so far is also applicable to the information processing system and the method of information processing without causing technical inconsistency.

Hereinafter, embodiments of the present disclosure will be described with reference to the drawings. The configuration of the following embodiments is illustrative, and is not intended to limit the present disclosure.

### First Embodiment

### System Outline

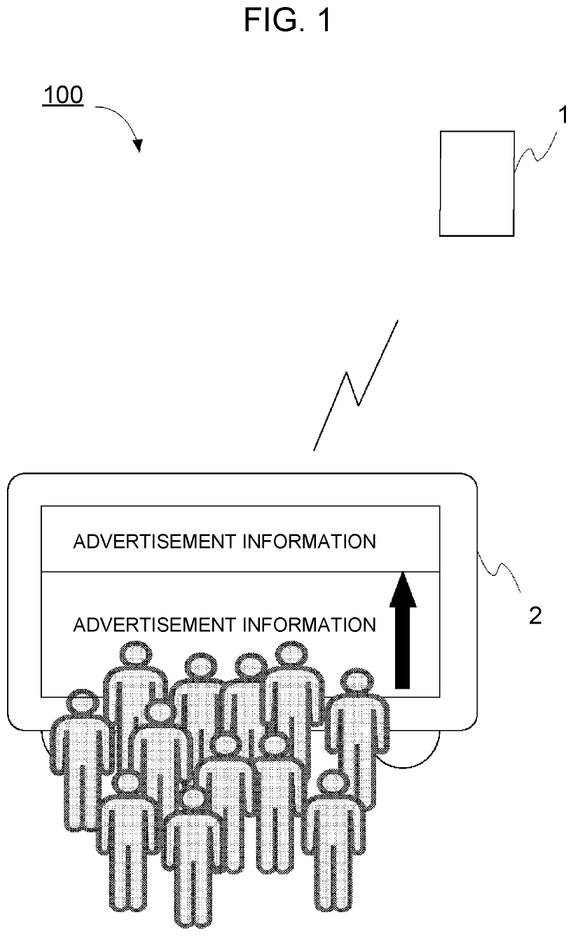

FIG. 1 shows an example of the system configuration of a vehicle advertisement display control system 100 according to a first embodiment. The vehicle advertisement display control system 100 is a system configured to determine a display position of advertisement information on display by a vehicle in accordance with a congestion degree around the vehicle. The vehicle advertisement display control system 100 includes a vehicle 2 and a center server 1 that controls a display position of an advertisement in the vehicle 2. The vehicle advertisement display control system 100 may also include a plurality of vehicles 2. The center server 1 is one example of “information processing apparatus.”

The vehicle 2 is a vehicle that can travel by autonomous driving or by unmanned driving, for example. The vehicle 2 may be a vehicle that travels by manual driving. The vehicle 2 includes a display device disposed on at least one of the side surfaces of a vehicle body, the display device having a size large enough to cover the entire side surface. In the first embodiment, the vehicles 2 are assumed to be mobile shops, such as a clothing store, a variety store, a shoe store, a florist, and a food store, respectively. These mobile shops are congregated to form a mobile shopping mall. However, without being limited to the mobile shops, the vehicles 2 may be advertising vehicles that display advertisement information on a display device disposed on a side surface of the vehicle body.

Each of the vehicles 2 is connected with the center server 1 through a wireless communication network, for example. Alternatively, the vehicles 2 may each be connected to the Internet through a wireless communication network, and be connected with the center server 1 through the Internet, for example. The vehicles 2 perform wireless communication in conformity with the standards of mobile communications, such as 3G long term evolution (LTE), and LTE Advanced, and in conformity with the standards of wireless LAN such as WiFi.

Upon reception of an operation command from the center server 1, the vehicle 2 generates an operation plan, and travels autonomously to a destination based on the operation plan. The vehicle 2 includes a device for acquiring location information. The location information is acquired at a prescribed cycle and transmitted to the center server 1. The vehicle 2 receives advertisement information displayed on a display device from the center server 1 in advance. In an initial state, the vehicle 2 displays the advertisement information on the entire screen of the display device by using as a display region of the advertisement information the entire region of the display screen of the display device.

In accordance with the congestion degree around the vehicle 2, the center server 1 controls a display position of the advertisement information in the display screen of the display device provided on a side surface of the vehicle 2. The congestion degree is, for example, the number of persons present in a prescribed area, for example. The center server 1 acquires the congestion degree at a prescribed cycle. The congestion degree is acquired based on, for example, the result of counting the number of visitors at an entrance of a venue, the result of image analysis of images imaged in the venue with a camera, the number of terminals accessing a WiFi access point, the number of visitors registered in advance, and the like.

When, for example, the congestion degree around the vehicle 2 is equal to or greater than a prescribed threshold, the center server 1 determines the display region of the advertisement information to be an upper region on the screen of the display device. When, for example, the congestion degree becomes lower than the prescribed threshold, the center server 1 determines the display region of the advertisement information to be the entire region of the screen of the display device. The center server 1 transmits to the vehicle 2 the determined display region of the advertisement information, together with a display position change command. Upon reception of the display position change command from the center server 1, the vehicle 2 displays advertisement information in a specified display region on the display device.

In the first embodiment, the display region of the advertisement information displayed on the display device of the vehicle 2 is determined in accordance with the congestion degree around the vehicle 2. For example, when the congestion degree around the vehicle 2 increases, the display region of the advertisement information is changed to an upper region on the screen. For example, when the area in front of the display device is congested, it is hard for the persons positioned behind the congestion to view the displayed information on the display screen. Displaying the advertisement information on an upper region on the display screen allows the persons who are, for example, positioned behind the people in front of the display device to easily view the advertisement information. Therefore, the advertisement information can be presented to more people. When the congestion degree around the vehicle 2 is low, the advertisement information is displayed on the entire screen of the display device of the vehicle 2 so as to present easily viewable advertisement information.

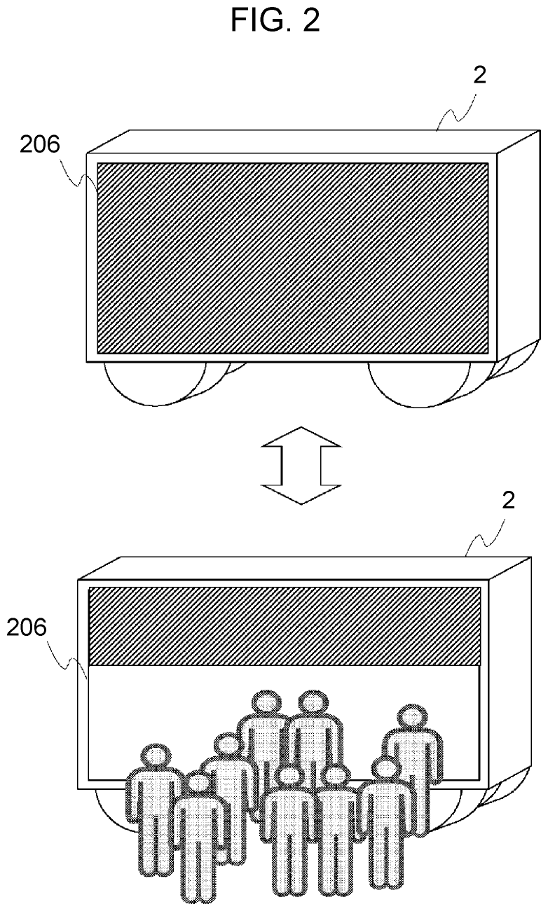

FIG. 2 shows an example of transition of the display region of the advertisement information on the display device of the vehicle 2. The vehicle 2 has the shape of, for example, an approximately rectangular solid, with facing two side surfaces being identical in size. In FIG. 2, a display 206 is disposed on one of or both the larger surfaces, out of the side surfaces of the vehicle 2. The display 206 has a size practically the same as the larger side surfaces. However, without being limited to this configuration, the display 206 may be disposed in each of the side surfaces of the vehicle 2. The first embodiment is described on the assumption that the display 206 is disposed on one of the largest side surfaces of the vehicle 2.

For example, in the first embodiment, prescribed advertisement information is displayed on the display 206, when the vehicle 2 used as a mobile shop is parked outside shop hours, or when the vehicle 2 used as an advertising vehicle is parked. In FIG. 2, a shadow portion represents a region where the advertisement information is displayed. In the first embodiment, when the congestion degree is less than the prescribed threshold, the advertisement information is displayed on the entire screen of the display 206 of the vehicle 2 (upper drawing in FIG. 2). Display on the entire screen of the display 206 is hereinafter referred to as a full screen display.

Meanwhile, when the congestion degree becomes equal to or greater than the prescribed threshold, advertisement information is displayed in an upper partial region on the display 206 of the vehicle 2 (lower drawing in FIG. 2). Display in the partial region on the display 206 is hereinafter referred to as a partial screen display.

In the case of the partial screen display, reduced display of the advertisement information may be performed such that the advertisement information is all fit into the partial region. Alternatively, advertisement information for full screen display and advertisement information for partial screen display may be prepared in advance for one advertisement. For full screen display, the advertisement information for full screen display may be displayed, and for partial screen display, the advertisement information for partial screen display may be displayed. The advertisement information for partial screen display may include data that is also included in the advertisement information for full screen display. The data includes the name of a commodity, a mark relating to the commodity, the name of an advertiser, a mark relating to the advertiser, and a catch copy. The advertisement information may include a static image, a moving image, and voice.

A threshold used for determining a transition from the full screen display to the partial screen display may be identical to or different from a threshold used for determining a transition from the partial screen display to the full screen display. When the thresholds are different, the threshold used for determining the transition from the partial screen display to the full screen display is larger than the threshold used for determining the transition from the full screen display to the partial screen display. The threshold used for determining the transition from the full screen display to the partial screen display is an example of “first threshold.” The threshold used for determining the transition from the partial screen display to the full screen display is an example of “second threshold.”

The full screen display indicates that the region used as a display target of advertisement information is the entire screen of the display 206, and does not necessarily indicates that the advertisement information is displayed over the entire screen of the display 206. For example, when the size of a static image or a moving image of the advertisement information is smaller than the screen of the display 206, or when the image of the advertisement information is different in aspect ratio from the screen of the display 206, an actual display size of the advertisement information becomes smaller than the screen size of the display 206.

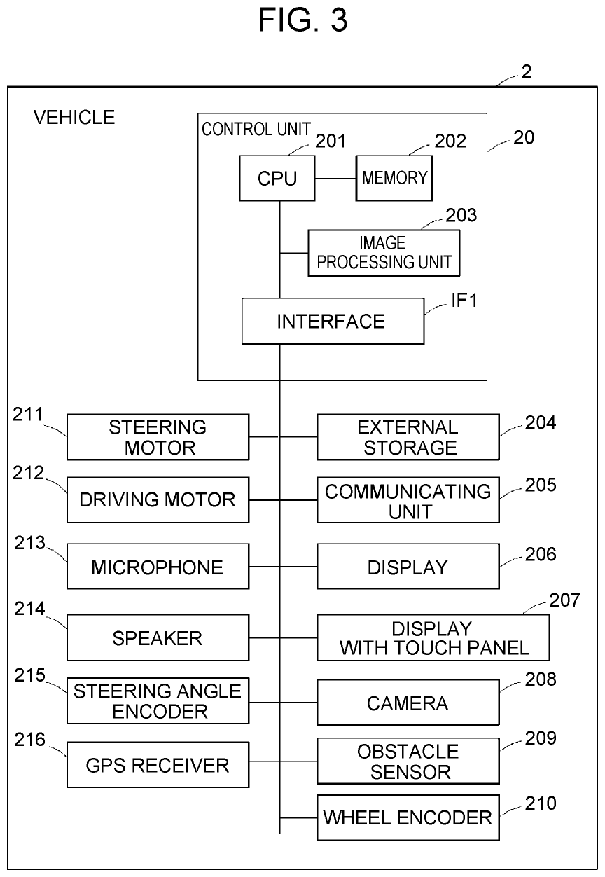

FIG. 3 shows an example of the hardware configuration of the vehicle 2. FIG. 3 is described on the assumption that the vehicle 2 can travel autonomously. In FIG. 3, the hardware relating to a control system is extracted and depicted.

The vehicle 2 includes a control unit 20, an external storage 204, a communication unit 205, a display 206, a display 207 with a touch panel, a camera 208, an obstacle sensor 209, a wheel encoder 210, a steering motor 211, a driving motor 212, a microphone 213, a speaker 214, a steering angle encoder 215, and a global positioning system (GPS) receiver 216.

The control unit 20 is also called an engine control unit (ECU). The control unit 20 includes a CPU 201, a memory 202, an image processing unit 203, and an interface IF1. The interface IF1 is connected to the external storage 204, the communication unit 205, the display 206, the display 207 with a touch panel, the camera 208, the obstacle sensor 209, the wheel encoder 210, the steering motor 211, the driving motor 212, the microphone 213, the speaker 214, the steering angle encoder 215, and the GPS receiver 216.

The obstacle sensor 209 is an ultrasonic sensor, a radar, or the like. The obstacle sensor 209 emits a wave, such as an ultrasonic wave, and an electromagnetic wave, in a detection target direction, and detects, based on a reflected wave, the presence, position, relative speed, and the like, of an obstacle in the detection target direction. Examples of the obstacle include a pedestrian, a bicycle, a structure, and a building. For example, when the vehicle 2 has a box-like body, a plurality of obstacle sensors 209 are provided. The obstacle sensors 209 are provided at positions in the vicinity of four corners including front, rear, right, and left corners of the vehicle 2. The front, rear, right, and left of the vehicle 2 are determined in accordance with a travel direction, for example.

The camera 208 is an imaging device using an image sensor, such as a charge-coupled device (CCD), a metal-oxide-semiconductor (MOS), or a complementary metal-oxide-semiconductor (CMOS). The camera 208 acquires an image at a predetermined time interval called a frame period, and stores the images in a frame buffer in the control unit 20. The vehicle 2 is equipped with a plurality of cameras 208. The cameras 208 are, for example, disposed facing outside on front, rear, right, and left side surfaces of the vehicle 2. However, without being limited to this configuration, examples of the cameras 208 may include a camera disposed facing inside. The parameters of the camera 208 such as an image viewing angle and an imaging range, may be set within a prescribed range.

In accordance with an instruction signal from the control unit 20, the steering motor 211 controls an angle in the direction of a cross line between rotating surfaces of wheels and a horizontal plane, i.e., an angle in the direction of movement by rotation of the wheels. For example, the driving motor 212 drives and controls four wheels included in the vehicle 2 in accordance with an instruction signal from the control unit 20. The driving motor 212 may drive any one of two pairs of wheels: a pair of front wheels; and a pair of rear wheels.

The steering angle encoder 215 detects a steering angle representing a travel direction of the wheels at prescribed detection time intervals, and stores the steering angle in a register of the control unit 20. The steering angle is an angle of a rotary shaft of the wheels in the horizontal plane. For example, the origin of the angle is set in the direction where the rotary shafts of the wheels are orthogonal to the travel direction of the vehicle 2. The wheel encoder 210 acquires a rotation angle of the wheels at prescribed detection time intervals, and stores the rotation angle in the register of the control unit 20.

For example, the communication unit 205 is for connecting to WiFi access points or mobile phone base stations, and communicating, through a public communication network connected to the access points or base stations, with various servers, or the like, on the network. The communication unit 205 performs wireless communication by radio signal and wireless communication systems in conformity with prescribed wireless communication standards.

The GPS receiver 216 receives electric waves representing time signals from a plurality of satellites (global positioning satellites) that revolve the Earth, and stores the electric waves in the register of the control unit 20. The microphone 213 detects voice, converts the voice into a digital signal, and stores the digital signal in the register of the control unit 20. The speaker 214 is driven by a D-A converter and an amplifier that are connected to the control unit 20 or a signal processing unit, and reproduces acoustic data including sound and voice. The microphone 213 and the speaker 214 may include those disposed facing inside the vehicle 2 and those disposed facing outside the vehicle 2.

The display 206 is provided, for example, facing outside the vehicle 2 on at least one side surface of the body of the vehicle 2. Examples of the display 206 include a liquid crystal display and an electro luminescence panel. The display 206 may be a display having a screen that can be divided into predetermined sections, such as vertically divided two sections, and vertically and horizontally divided four sections. The content to be displayed in each divided display section of the display 206 may be specified. Alternatively, the display may be a display having a screen region that can optionally be divided. The display 206 is not limited to the display having a screen dividable into sections. Any display may be used as long as a display region for specified data can optionally be specified.

The display 207 with a touch panel is an input device for inputting an instruction from a user. For example, the display 207 with a touch panel is disposed facing inside the vehicle 2. However, without being limited to this configuration, the display 207 with a touch panel may be disposed facing outside in the vicinity of a door of the vehicle 2, for example.

The CPU 201 of the control unit 20 executes computer programs executably expanded in the memory 202 so as to execute the processes as the control unit 20. The memory 202 stores the computer programs executed by the CPU 201, data processed by the CPU 201, and the like. The memory 202 is, for example, a dynamic random access memory (DRAM), a static random access memory (SRAM), a read only memory (ROM), or the like. The image processing unit 203 cooperates with the CPU 201 to process frame buffer data obtained from the camera 208 at every prescribed frame period. The image processing unit 203 includes a GPU, and an image memory used as a frame buffer, for example. The external storage 204 is a nonvolatile storage device, such as a solid state drive (SSD), and a hard disk drive.

For example, the control unit 20 acquires a detection signal from the sensor of each unit of the vehicle 2 through the interface IF1. The control unit 20 also calculates the latitude and longitude representing the location on the Earth with a detection signal from the GPS receiver 216. The control unit 20 further acquires map data from a map information database stored in the external storage 204, and collates the calculated latitude and longitude with the location on the map data to determine a current location. The control unit 20 also acquires a route from the current location to the destination on the map data. The control unit 20 also detects an obstacle around the vehicle 2 based on signals from the obstacle sensor 209, the camera 208, and the like. The control unit 20 determines a travel direction, and controls the steering angle so as to avoid the obstacle.

The control unit 20 further cooperates with the image processing unit 203 to process images, which are acquired from the camera 208, in units of frame data, and detects, for example, a change based on difference in images to recognize an obstacle. The control unit 20 may transmit, from the communication unit 205 to the center server 1 on the network, the frame data of images from the camera 208 and voice data obtained from the microphone 213. Then, the center server 1 may perform analysis of the frame data of images and the voice data.

The control unit 20 may further display images, characters, and other information on the display 206. The control unit 20 also detects operation performed on the display 207 with a touch panel, and receives an instruction from a user.

Although the interface IF1 is illustrated in FIG. 3, transfer of signals between the control unit 20 and a controlled object is not necessarily performed only through the interface IF1. In short, the control unit 20 may have a plurality of signal transfer routes other than the interface IF1. In FIG. 3, the control unit 20 has a single CPU 201. However, the CPU is not necessarily limited to a single processor. Instead, the CPU may have a multiprocessor configuration. A single CPU connected through a single socket may have a multi-core configuration. At least some of the processes in the respective units may be performed by exclusive processors other than the CPU, such as a digital signal processor (DSP) and a graphics processing unit (GPU). At least some of the processes in the respective units may be performed by an integrated circuit (IC) or other digital circuits. At least some of the respective units may include an analog circuit.

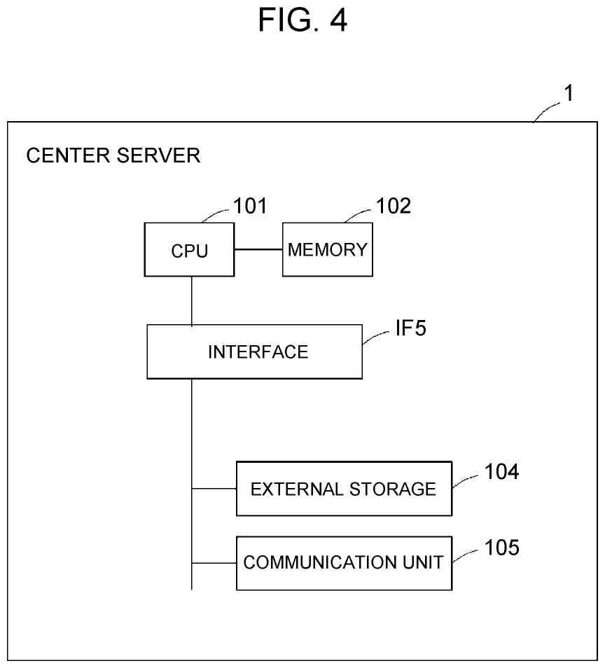

FIG. 4 illustrates the hardware configuration of the center server 1. The center server 1 includes a CPU 101, a memory 102, an interface IFS, an external storage 104, and a communication unit 105. The configuration and function of the CPU 101, the memory 102, the interface IFS, and the external storage 104 are similar to those of the CPU 201, the memory 202, the interface IF1, and the external storage 204 of FIG. 3. The CPU 101 is an example of “control unit.”

The communication unit 105 connects with a public communication network through a LAN, and communicates, through the public communication network, with various servers, the vehicle 2, and the like, on the network, for example. Alternatively, in the case where the center server 1 controls only the vehicle 2 in a venue as a control target, and the center server 1 is present in the venue, the center server 1 may be a mobile PC. In this case, the communication unit 105 performs wireless communication by radio signal and wireless communication systems in conformity with WiFi standards, for example. The communication unit 105 connects with a WiFi access point, and communicates with the vehicle 2 that is connected to the WiFi network.

However, the center server 1 is not limited to this configuration. When the center server 1 is a mobile PC, the communication unit 105 may connect with a mobile phone base station or an access point by a prescribed wireless communication system. Through the mobile phone base station or the access point, the communication unit 105 may connect with a public line communication network to communication with other apparatuses on the network. The hardware configuration of the center server 1 is not limited to the configuration shown in FIG. 4. The hardware configuration can properly be added or replaced in accordance with embodiments

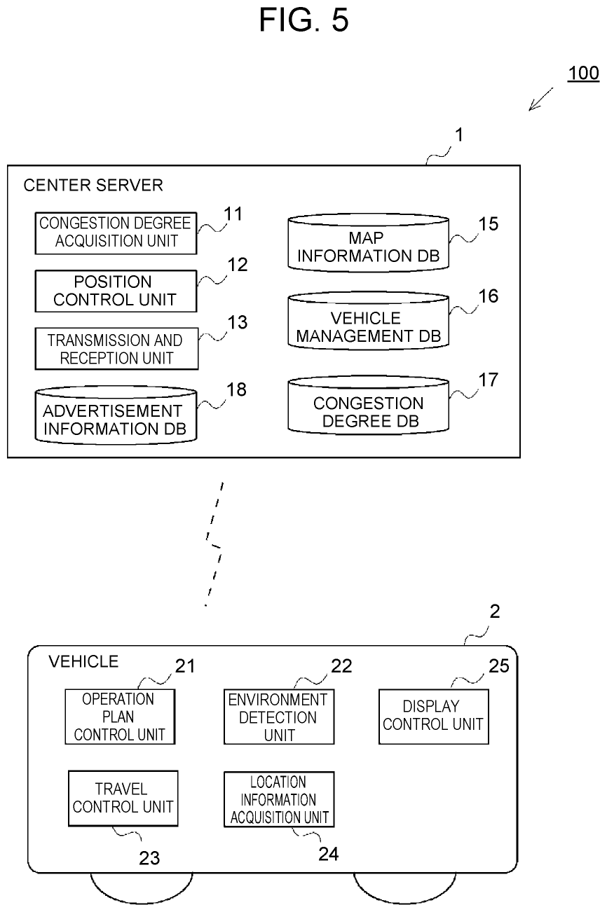

FIG. 5 shows an example of the functional configuration of the center server 1 and the vehicle 2 in the vehicle advertisement display control system 100. The center server 1 operates as each of the units illustrated in FIG. 5 through the computer programs on the memory 102. In short, the center server 1 includes, as functional components, a congestion degree acquisition unit 11, a position control unit 12, a transmission and reception unit 13, a map information database (DB) 15, a vehicle management DB 16, a congestion degree DB 17, and an advertisement information DB 18.

The transmission and reception unit 13 is an interface between the vehicle 2 and various servers. The transmission and reception unit 13 properly outputs the information received through the communication unit 105 to the congestion degree acquisition unit 11 or the position control unit 12. The transmission and reception unit 13 transmits the information input from the congestion degree acquisition unit 11 or the position control unit 12 to a specified address through the communication unit 105.

The congestion degree acquisition unit 11 acquires a congestion degree around the vehicle 2 at a prescribed cycle, for example. The congestion degree acquisition unit 11 stores the acquired congestion degree in a prescribed storage area of the memory 102. Held in the prescribed storage area of the memory 102 is the congestion degree around the vehicle 2 that is acquired, for example, at a prescribed period. The congestion degrees are deleted in sequence when their specified periods are expired. The congestion degree around the vehicle 2 is acquired by using, for example, one or more pieces of the following information, with reference to a congestion degree table stored in the later-described congestion degree DB 17. The acquisition period of the congestion degree around the vehicle 2 is set in units of one minute to one hour, for example.

(1) An image analysis process may be performed on an image imaged with a camera disposed in the periphery pf the vehicle 2, or an image imaged with the camera 208 disposed facing outside the vehicle 2. With the number of persons in the imaged image obtained as a result of the image analysis, the congestion degree may be acquired. In this case, the congestion degree acquisition unit 11 receives, through the transmission and reception unit 13, the imaged image at a prescribed cycle from the camera disposed in the periphery of the vehicle 2, or the camera 208 facing outside the vehicle 2. For example, when there are a plurality of cameras used for acquisition of the congestion degree, the imaging range of the cameras is adjusted to be identical, and an average of the number of persons in the images imaged with the cameras is used as the congestion degree. When the camera 208 of the vehicle 2 is used, the vehicle 2 may perform image analysis, and report the number of persons in the imaged image to the center server 1. When the camera disposed in the periphery of the vehicle 2 is used, the congestion degree acquisition unit 11 identifies, as a camera for use in acquiring the congestion degree in the periphery of the vehicle 2, a camera having, for example, an imaging range that partially or entirely covers the vehicle 2, based on the information on the location of the vehicle 2 and the installation location of the camera included in the map information DB.

(2) The congestion degree may be acquired by using the number of terminals connecting a WiFi access point installed in a venue, the number of terminals being acquired from the WiFi access point. In this case, the congestion degree acquisition unit 11 identifies the access point installed within a prescribed distance from the vehicle 2 based on the information on the location of the vehicle 2, and acquires from the access point the number of connecting terminals at a prescribed cycle through the transmission and reception unit 13. When there are a plurality of access points installed within a prescribed distance from the vehicle 2, an average of the number of connection terminals may be used. The congestion degree around the vehicle 2 may be acquired by using the information on the location of the terminals registered in the mobile phone base station of each communication provider, instead of the number of terminals connecting the access point.

(3) The congestion degree may be acquired using the number of visitors counted at an entrance and exit gate of the venue. For example, the number of visitors per prescribed unit time, a value obtained by subtracting the number of leaving persons from the number of visitors summed up from the opening time, or the like, is used as the congestion degree. The number of visitors and the number of leaving persons at the entrance and exit gate are acquired based on, for example, counting performed by staff, an entrance and exit record provided by a near field communication (NFC) device disposed at the entrance and exit gate, or the like. In this case, the congestion degree acquisition unit 11 acquires, through the transmission and reception unit 13, the number of visitors and the number of leaving persons, from a terminal carried by the staff, or the NFC device holding the entrance and exit record.

(4) For example, in the case where reservation is required to visit a mobile shopping mall, the center server 1 may receive information on reservation for visit from a server holding the information on reservation for visit, acquire the current number of visitors from the information on reservation for visit, and may acquire the congestion degree from the number of visitors.

In the methods (3) and (4), instead of acquiring a local congestion degree around the vehicle 2, the congestion degree of the entire venue is acquired and used as the congestion degree around the vehicle 2.

The position control unit 12 performs an advertisement display position control process at a prescribed cycle. The advertisement display position control process is for controlling the display position of the advertisement information on the display 206 of the vehicle 2. The advertisement display position control process is executed, for example, at a prescribed cycle for every vehicle 2. The execution cycle of the advertisement display position control process is optionally set in units of one second to one minute, for example.

Specifically, at the execution timing of the advertisement display position control process, the position control unit 12 acquires, for example, a latest congestion degree around the vehicle 2 from a prescribed storage area of the memory 102. The position control unit 12 compares, for example, the latest congestion degree around the vehicle 2 with a threshold stored in the congestion degree DB 17, and determines full screen display or partial screen display of the advertisement information in accordance with whether the congestion degree is higher or lower than the threshold. When the partial screen display of the advertisement information on the display 206 of the vehicle 2 is determined, the position control unit 12 also determines a display region of the advertisement information, the type of advertisement information to be displayed (advertisement information for partial screen display) or whether to reduce the advertisement information, and the like. The position control unit 12 transmits a display position change command to the vehicle 2. Transmitted together with the display position change command are identification information of the display to be used, the display region of the advertisement information, the type of the advertisement information to be displayed or whether to reduce the advertisement information, and the like. The advertisement information itself may also be transmitted with the display position change command.

The map information DB 15, the vehicle management DB 16, the congestion degree DB 17, and the advertisement information DB 18 each are generated in the external storage 104 of the center server 1. The map information DB 15, the vehicle management DB 16, and the congestion degree DB 17 are, for example, relational databases, respectively.

The movement information DB 15 stores, for example, map information regarding the inside of the venue, installation locations of the cameras in the venue, and the installation location of an access point. The vehicle management DB 16 includes, for example, identification information of the vehicle 2, information regarding the display 206 included in the vehicle 2, information on the camera 208 included in the vehicle 2, and identification information of the advertisement information allocated to the vehicle 2. The information regarding the display 206 includes, for example, a display size, a dividable number, or whether a dividable size can optionally be set. The information regarding the camera 208 includes information on the display 206 that is disposed on the same side surface of the vehicle 2 and that is associated with the camera 208, and information on a field angle range of the camera 208.

Stored in the congestion degree DB 17 are a threshold 1 used for determining a transition from the full screen display to the partial screen display, and a threshold 2 used for determining a transition from the partial screen display to the full screen display. The relationship between the threshold 1 and the threshold 2 is defined as threshold 1 threshold 2. The values of the threshold 1 and the threshold 2 are preset in accordance with the information used as the congestion degree around the vehicle 2. Stored in the advertisement information DB 18 are advertisement information files and information regarding advertisement information. The details about the information regarding the advertisement information will be described later.

Some of the functional components of the center server 1 or some of the processes thereof may be executed by other computers connected to the network. Although a series of processes executed in the center server 1 can also be executed by hardware, the processes can also be executed by software.

Now, the vehicle 2 operates as each of the units illustrated in FIG. 5 through the computer programs on the memory. For example, the vehicle 2 includes, as functional components, an operation plan control unit 21, an environment detection unit 22, a travel control unit 23, a location information acquisition unit 24, and a display control unit 25. The operation plan control unit 21, the environment detection unit 22, the travel control unit 23, the location information acquisition unit 24, and the display control unit 25 are functional components achieved when the CPU 201 executes the programs on the memory 202, for example.

The location information acquisition unit 24 transmits to the center server 1 the information on the location of the vehicle 2 that is acquired, for example, by the GPS receiver 216 or the like, at a prescribed cycle. The information on the location of the vehicle 2 is the latitude and longitude, for example. Alternatively, the information on the location of the vehicle 2 may be an address, for example. The information on the location of the vehicle 2 acquired by the location information acquisition unit 24 is also output to the operation plan control unit 21 and the travel control unit 23, for example.

The operation plan control unit 21 receives an operation command from the center server 1, and a command for changing a display position. Based on the operation command and the location information on the own vehicle obtained by the location information acquisition unit 24, the operation plan control unit 21 calculates a route for the vehicle 2 to travel, and generates an operation plan. The operation plan includes data regarding the thus-calculated route for the vehicle 2 to travel, and the data that defines the processes to be performed by the vehicle 2 in some or all parts of the route. Examples of the processes to be performed by the vehicle 2 include changing the direction of the vehicle 2. The operation plan control unit 21 outputs the generated operation plan to the travel control unit 23.

Based on the data acquired by various sensors mounted on the vehicle 2, the environment detection unit 22 detects information regarding an environment around the vehicle 2 used for autonomous travel. Examples of the detection targets of the environment detection unit 22 include the number and location of lanes, the number and location of the vehicles present around the own vehicle, the number and location of obstacles (for example, pedestrians, bicycles, structures, buildings, and the like) present around the own vehicle, the structure of roads, and road signs. However, the detection targets are not limited to these. The detection targets may be any objects as long as the objects are used for autonomous travel. For example, when the sensor is a stereoscopic camera, the objects around the vehicle 2 are detected by performing image processing of image data imaged by the stereoscopic camera. The data on the environment around the vehicle 2 detected by the environment detection unit 22 is transmitted to the travel control unit 23 described later.

The environment detection unit 22 transmits an image imaged with the camera 208 to the center server 1 in response to a request from the center server 1. The center server 1 requests the image imaged with the camera 208 when, for example, the image imaged with the camera 208 is used for acquisition of the congestion degree. When the center server 1 requests transmission of the imaged image at a prescribed cycle, the environment detection unit 22 transmits the image imaged with the camera 208 to the center server 1 at a prescribed cycle.

The travel control unit 23 generates a control command for controlling autonomous travel of the own vehicle based on, for example, the operation plan generated by the operation plan control unit 21, the data regarding the environment around the vehicle 2 generated by the environment detection unit 22, and on the location information regarding the own vehicle acquired by the location information acquisition unit 24. For example, when an operation plan is input from the operation plan control unit 21, the travel control unit 23 determines whether or not an obstacle is present in a moving direction indicated by the operation plan, and secures the safety of movement. When it is determined that no obstacle is present in the moving direction, the travel control unit 23 generates a control command for controlling the own vehicle to travel on the route based on the operation plan. The generated control command is transmitted to the driving motor 212. As a method of generating the control command for achieving autonomous travel of the vehicle, a publicly-known method may be adopted.

The display control unit 25 performs display control of the display 206. For example, upon reception of a display position change command from the center server 1, the display control unit 25 performs display control of the advertisement information in the specified display 206. For example, when the display position change command indicating partial screen display is received during full screen display of the advertisement information in the specified display 206, the display control unit 25 displays the advertisement information in a specified partial region on the specified display 206. For example, when the display position change command indicating full screen display is received during partial screen display of the advertisement information in the specified display 206, the display control unit 25 displays the advertisement information on the entire screen in the specified display 206.

For example, when the display position change command indicating full screen display is received during full screen display of the advertisement information in the specified display 206, the display control unit 25 does not change the display state of the advertisement information in the specified 206. For example, when the display position change command indicating partial screen display is received during partial screen display of the advertisement information in the specified display 206, and there is no change in partial region, the display control unit 25 does not change the display state of the advertisement information in the specified 206. For example, when the display position change command indicating partial screen display is received during partial screen display of the advertisement information in the specified display 206, and there is a change in the partial region, the display control unit 25 displays the advertisement information in a specified display region on the specified display 206.

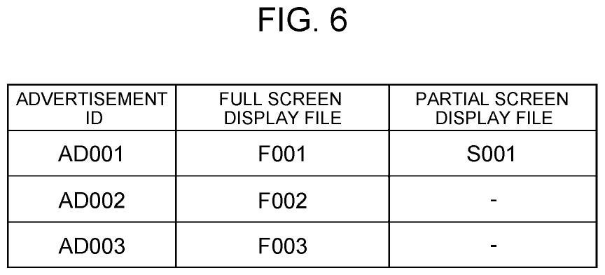

FIG. 6 shows an example of an advertisement information management table held in the advertisement information DB 18. The advertisement information management table is for holding the information regarding advertisement information. In the example shown in FIG. 6, the advertisement information management table includes fields of an advertising ID, a full screen display file, and a partial screen display file.

Stored in the field of the advertising ID is identification information of advertisement information. Stored in the field of the full-screen display file is identification information of a file of advertisement information for full-screen display. Stored in the field of the partial screen display file is identification information of a file of advertisement information for partial screen display. The field of partial screen display is empty or Null when no advertisement information is prepared for partial screen display.

The advertisement information management table is stored in the center server 1 in advance. The data structure of the advertisement information management table is not limited to the data structure shown in FIG. 6.

### Process Flow

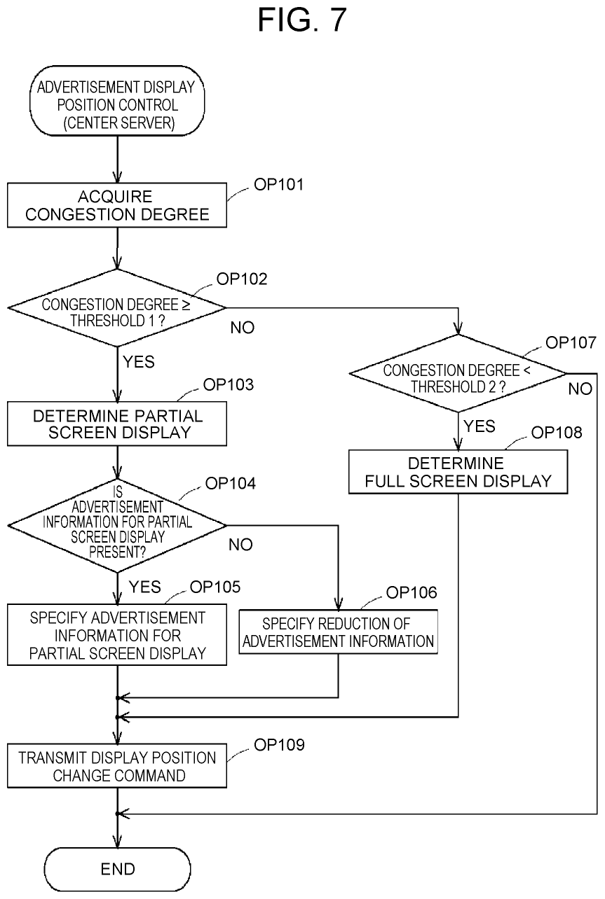

FIG. 7 is an example of a flowchart for the advertisement display position control process of the center server 1. The process shown in FIG. 7 is repeatedly executed at a prescribed cycle for every vehicle 2 that displays advertisement information on the display 206 during parking, for example. When advertisement information is displayed on a plurality of displays 206 of the vehicle 2, the process shown in FIG. 7 is repeatedly executed at a prescribed cycle for every display 206. Although the process shown in FIG. 7 is executed by the CPU 101 of the center server 1, the process is described as being executed by the position control unit 12 that is a functional component for the sake of convenience.

In OP101, the position control unit 12 acquires the latest congestion degree around the vehicle 2 from a prescribed storage area in the memory 102. When the congestion degree around the vehicle 2 is acquired from an image imaged with the camera 208 of the vehicle 2, the congestion degree acquisition unit 11 may transmit to the vehicle 2 an acquisition request of the image imaged with the camera 208, acquire the image imaged with the camera 208 of the vehicle 2, and acquire the congestion degree around the vehicle 2 from the imaged image in OP101. In this case, for example, the camera 208 corresponding to the display 206 of the vehicle 2 may be identified from the vehicle management DB 16, and the identified camera 208 may be specified in the acquisition request of the imaged image.

In OP102, the position control unit 12 determines whether or not the congestion degree around the vehicle 2 is equal to or greater than a threshold 1. When the congestion degree around the vehicle 2 is equal to or greater than the threshold 1 (OP102: YES), the process proceeds to OP103. When the congestion degree around the vehicle 2 is less than the threshold 1 (OP102: NO), the process proceeds to OP107.

The process of OP103 to OP106 is performed in the case where the congestion degree around the vehicle 2 is equal to or greater than the threshold 1. In OP103, the position control unit 12 determines to perform partial screen display of the advertisement information on the display 206 of the vehicle 2. The position control unit 12 also determines a partial region that is the display region where the advertisement information is displayed, based on the information on the display 206 of the vehicle 2 held in the vehicle management information DB 16, for example. In OP103, the position control unit 12 determines the partial region where the advertisement information is displayed to be an upper region on the screen of the display 206. The method of determining the partial region where advertisement information is displayed is not limited to any specific method.

For example, when the display 206 is a display vertically dividable into two sections, the position control unit 12 determines an upper partial region as the display region of the advertisement information. For example, when the display 206 has a display region that can optionally be specified, the position control unit 12 determines a prescribed range from the top of the screen of the display 206 as a display region of advertisement. As the congestion degree is higher, the position control unit 12 may set the position of the partial region where the advertisement information is displayed to a higher position on the screen of the display 206.

In OP104, the position control unit 12 determines whether or not the advertisement information corresponding to the display 206 of the vehicle 2 includes advertisement information for partial screen display. The advertisement information corresponding to the display 206 of the vehicle 2 can be identified based on the vehicle management DB 16, for example. Whether or not advertisement information for partial screen display is present in the advertisement information corresponding to the display 206 of the vehicle 2 can be identified based on, for example, whether the advertisement information DB 18 holds the advertisement information for partial screen display corresponding to the identification information of the advertisement information.

When the advertisement information for partial screen display is present in the advertisement information corresponding to the display 206 of the vehicle 2 (OP104: YES), the process proceeds to OP105. In OP105, the position control unit 12 specifies the advertisement information for partial screen display as the type of advertisement information to be displayed.

When the advertisement information for partial screen display is not present in the advertisement information corresponding to the display 206 of the vehicle 2 (OP104: NO), the process proceed to OP106. In OP106, the position control unit 12 specifies reduced display of the advertisement information for full screen display.

The processes of OP107 and OP108 are performed in the case where the congestion degree around the vehicle 2 is less than the threshold 1. In OP107, the position control unit 12 determines whether or not the congestion degree around the vehicle 2 is less than a threshold 2. When the congestion degree around the vehicle 2 is less than the threshold 2 (OP107: YES), the process proceeds to OP108. In OP108, the position control unit 12 determines full screen display of the advertisement information, i.e., determines the display region of the advertisement information to be the entire screen of the display 206 of the vehicle 2.

When the congestion degree around the vehicle 2 is equal to or greater than the threshold 2 and less than the threshold 1 (OP107: NO), the position control unit 12 determines to maintain the present display position of the advertisement information, and ends the process shown in FIG. 7.

In OP109, the position control unit 12 sends a display position change command to the vehicle 2. For example, the identification information of the display 206, whether specification of full screen display or partial screen display, the display region of the advertisement information, the type of the advertisement information or reduced display, and the like, are also transmitted to the vehicle 2 with the display position change command. Then, the process shown in FIG. 7 is ended.

When the vehicle 2 receives the display position change command from the center server 1, display of the advertisement information on the display 206 is controlled based on the display position change command.

### Operational Effects of First Embodiment

In the first embodiment, when the congestion degree around the vehicle 2 increases to a prescribed threshold or more, the display region of the advertisement information displayed on the display 206 of the vehicle 2 moves upward, and the advertisement information is presented at a higher position. This enables persons positioned behind a crowd formed in front of the display 206 to visibly recognize the advertisement information.

In the first embodiment, when the display region of the advertisement information moves upward on the display 206, reduced display of the advertisement information may be performed such that the advertisement information is fit in the upper region. This enables the persons around the vehicle 2 to view the entire advertisement information with ease.

In the first embodiment, when the display region of the advertisement information moves upward on the display 206, only part of the advertisement information (advertisement information for partial screen display) may be displayed on the upper region. When the display region of the advertisement information is set to the upper region of the display 206, the display range is narrowed. Accordingly, the characters, or the like, included in the advertisement information may also be downsized, which may compromise viewability. Accordingly, a point of the advertisement information that is desired to be appealed in particular may be used as the advertisement information for partial screen display. With this configuration, even when the congestion degree around the vehicle 2 increases, and the display region of the advertisement information is narrowed into an upper region on the screen of the display 206, the persons around the vehicle 2 can easily view the point of the advertisement information desired to be appealed.

In the first embodiment, when the congestion degree around the vehicle 2 drops below a prescribed threshold, the advertisement information displayed on the display 206 of the vehicle 2 is displayed on the entire screen. When there is a small crowd in front of the display 206, displaying the advertisement information on the entire screen enables the advertisement information to be visually recognized with more ease.

### Modifications

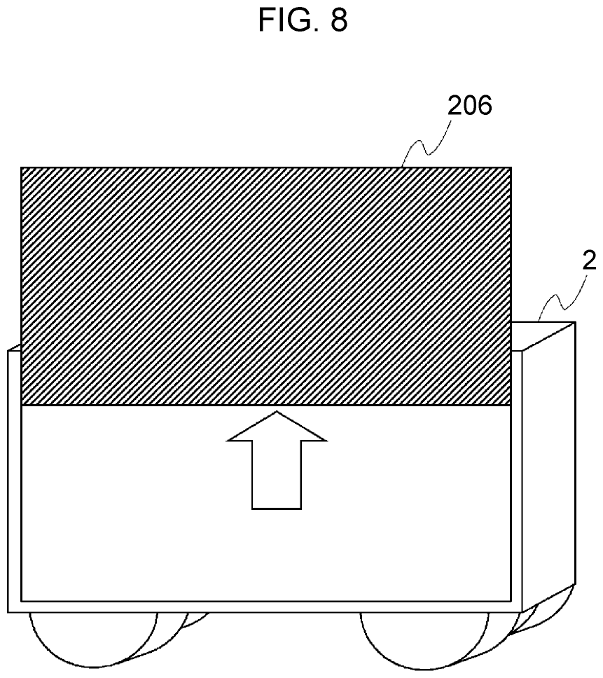

FIG. 8 is an example of an appearance view of a vehicle including the mechanism for pulling up the display 206. In the first embodiment, when the congestion degree around the vehicle 2 exceeds a prescribed threshold, advertisement information is presented at a higher position by setting the display region of the advertisement information displayed on the display 206 to an upper partial region on the screen of the display 206. Instead of this configuration, when the vehicle 2 has the mechanism of pulling up the display 206, the vehicle 2 may pull up the display 206 depending on the congestion degree.

In this case, in the process of the center server 1 in the first embodiment, determination of partial screen display may be replaced with determination of pulling up the display 206, and determination of the region where advertisement information is displayed may be replaced with determination of a pulling-up amount of the display 206. In the process of the center server 1 in the first embodiment, determination of the full screen display may be replaced with determination of pulling down the display 206. The center server 1 may also be configured to pull up the display 206 higher, as the congestion degree around the vehicle 2 is higher.

The vehicle 2 may also execute the process executed by the center server 1 in the first embodiment. When the vehicle 2 executes the process executed by the center server 1 in the first embodiment, the vehicle 2 may hold the information regarding the display 206, the advertisement information to be displayed, and the congestion degree DB 17. The vehicle 2 itself may acquire the congestion degree around the vehicle 2 from the camera 208 of the vehicle 2, or may make an inquiry to the center server 1 to acquire the congestion degree from the center server 1.

The vehicle 2 may perform some of the processes of the center server 1 in the first embodiment. For example, when the center server 1 determines full-screen display or partial screen display, the vehicle 2 may determine the display region of the advertisement information in partial screen display.

### Other Embodiments

The aforementioned embodiment is merely an example, and the present disclosure can suitably be changed and implemented without departing from the scope of the present disclosure.

In the first embodiment, the information displayed on the display 206 of the vehicle 2 has been described as advertisement information. However, the information displayed on the display 206 of the vehicle 2 is not limited to the advertisement information. When the information other than the advertisement information is displayed, the same process can also be applied.

In the description of the first embodiment, when advertisement information for partial screen display is not prepared as part of the advertisement information, reduction display of the advertisement information is performed at the time of performing partial screen display. However, the present disclosure is not limited to this configuration. For example, when the advertisement information for partial screen display is not prepared as part of the advertisement information, a process of extracting some information from the advertisement information may be performed, and the extracted information may be displayed in the partial region at the time of partial screen display.

The processes or devices described in the present disclosure can freely be combined and implemented without departing from the range of technical consistency.

Moreover, the process described to be performed by one device may be executed by a plurality of apparatuses in cooperation with each other. Alternatively, the processes described to be executed by different devices may be executed by one device. In the computer system, the hardware configuration (server configuration) that implements each function may flexibly be changed.

The present disclosure can also be implemented when a computer program, mounted with the functions described in the embodiments, is supplied to a computer, and one or more processors included in the computer read and execute the program. Such a computer program may be provided to the computer by a non-transitory computer readable storage medium that is connectable with a system bus of the computer, or may be provided to the computer through a network. Examples of the non-transitory computer readable storage medium include disks of any type, including magnetic disks (such as floppy (registered trademark) disks, and hard disk drives (HDD)) and optical discs (such as CD-ROM, DVD discs, Blu-ray Disc), and media of any type suitable for storing electronic commands, including read only memories (ROM), random-access memories (RAM), EPROM, EEPROM, magnetic cards, flash memories, and optical cards.

What is claimed is:

1. An information processing apparatus, comprising a control unit configured to execute:
acquiring a congestion degree of persons present around a vehicle including a display device disposed facing outside; and
determining a display position of advertisement information on the display device in accordance with the congestion degree.

2. The information processing apparatus according to claim 1, wherein when the congestion degree is equal to or greater than a first threshold, the control unit is configured to determine a display region of the advertisement information to be an upper region on a display screen of the display device.

3. The information processing apparatus according to claim 2, wherein when determining the display region of the advertisement information to be the upper region on the display screen, the control unit is configured to determine reduced display of the advertisement information such that the advertisement information is all fit in the upper region on the display screen.

4. The information processing apparatus according to claim 2, wherein when determining the display region of the advertisement information to be the upper region on the display screen, the control unit is configured to determine to display part of the advertisement information on the upper region on the display screen.

5. The information processing apparatus according to claim 2, wherein when the congestion degree is less than a second threshold that is equal to or less than the first threshold, the control unit is configured to determine the display region of the advertisement information to be an entire region of the display screen.

6. The information processing apparatus according to claim 1, wherein when the congestion degree is equal to or greater than the first threshold, the control unit is configured to determine to pull up the display device to a prescribed height.

7. The information processing apparatus according to claim 1, wherein the control unit is configured to acquire the congestion degree from an image imaged with an imaging device included in the vehicle, the imaging device being disposed facing outside.

8. An information processing system, comprising:
a vehicle including
a display device disposed facing outside, and
a first control unit configured to execute control so as to display advertisement information on the display device; and
an information processing apparatus including a second control unit configured to execute
acquiring a congestion degree of persons present around the vehicle, and
determining a display position of the advertisement information on the display device in accordance with the congestion degree.

9. A method of information processing, comprising:
acquiring a congestion degree of persons present around a vehicle including a display device disposed facing outside; and
determining a display position of advertisement information on the display device in accordance with the congestion degree.
